(19) United States
(12) Patent Application Publication
(10) Pub. No.: US 2020/0090118 A1
(43) Pub. Date: Mar. 19, 2020

(54) ELECTRONIC DEVICE AND METHOD FOR PROVIDING DELIVERY INFORMATION THEREFOR

(71) Applicant: Samsung Electronics Co., Ltd., Gyeonggi-do (KR)

(72) Inventors: Seonjae LIM, Incheon (KR); Dongho JANG, Gyeonggi-do (KR)

(21) Appl. No.: 16/346,153

(22) PCT Filed: Oct. 26, 2017
(86) PCT No.: PCT/KR2017/011935

§ 371 Date: Apr. 30, 2019

(30) Foreign Application Priority Data
Nov. 1, 2016 (KR) 10-2016-0144645

(51) Int. Cl. G06Q 10/08; G06Q 10/10

(52) U.S. Cl. CPC G06Q 10/0835; G06Q 10/109; G06Q 10/0838; G06Q 10/0832

(57) ABSTRACT

An electronic device according to various embodiments of the present invention comprises: a display; a communication module; a processor electrically connected to the display and the communication module; and a memory electrically connected to the processor, wherein the memory, during an execution thereof, can store instructions for enabling the processor to acquire information related to a user, to extract address information, which is related to a delivery, from the acquired information related to the user, to display, through the display, a shipping destination list including the extracted address information, and to receive an input for selecting the address information included in the shipping destination list. In addition, other various embodiments are possible.

### TECHNICAL FIELD

The disclosure relates to an electronic device and a method of the same to provide delivery information. More specifically, the disclosure relates to an electronic device and method capable of providing destination information to a user who buys a product using e-commerce, for example.

### BACKGROUND ART

E-commerce using the Internet is recently generalized. For example, a user may buy or sell products using various e-commerce methods, such as an online shopping mall, an Internet shopping mall, an open market, social commerce. As e-commerce is generalized, various service fields related to e-commerce also emerge. For example, a user may pay for a product purchased through e-commerce using various payment services (e.g., Samsung Pay™, Apple Pay™, PayPal™).

### DISCLOSURE OF INVENTION

### Technical Problem

When a user purchases a product using e-commerce, the user may directly input information related to the delivery of the product or use information already registered with a corresponding e-commerce service. For example, a user may use his or her address or office address, input when the user joined a corresponding e-commerce service, as destination information or may use destination information input at the time when the user purchases a product using a corresponding e-commerce service. However, as e-commerce methods are various and the number of online merchants providing e-commerce services increases, a user may purchase a product even without joining or logging in to an e-commerce service. In such a case, the user feels inconvenient because he or she has to directly input information related to the delivery of the product whenever when the user purchases the product. If the product purchased by the user is delivered to a different person, the user feels inconvenient because he or she has to directly input information related to the delivery of the product.

### Solution to Problem

According to an embodiment of the disclosure, an electronic device includes a display, a communication circuitry, a processor electrically connected to the display and the communication circuitry, and memory electrically connected to the processor. When the memory is executed, the memory may store instructions enabling the processor to obtain information related to a user, may obtain address information related to delivery from the obtained information related to the user, may display a destination list including the obtained address information on the display, and may receive an input to select address information included in the destination list.

According to an embodiment of the disclosure, an electronic device providing payment service includes a communication circuitry, at least one processor electrically connected to the communication circuitry, and memory electrically connected to the at least one processor. The memory may store at least one of address information related to delivery. The processor may be configured to obtain a request for the transmission of a destination list from an external electronic device, generate a destination list including the at least one of address information related to the delivery when the request for the transmission of the destination list is obtained from the external electronic device, and transmit the generated destination list to the external electronic device.

According to an embodiment of the disclosure, a method for an electronic device to provide delivery information may include obtaining a request for the transmission of a destination list from an external electronic device, generating the destination list including at least one of address information related to delivery based on the request for the transmission of the destination list obtained from the external electronic device, and transmitting the generated destination list to the external electronic device.

### Advantageous Effects of Invention

In accordance with various embodiments of the disclosure, the electronic device can provide a user with various pieces of address information related to the delivery of a product using information related to the user and/or the services of various fields related to e-commerce, such as payment-related service and finance-related service.

In accordance with various embodiments of the disclosure, the electronic device can provide a user with address information on a person and a place related to the user, in addition to information on the address of the user, as various pieces of address information related to the delivery of a product.

### BRIEF DESCRIPTION OF DRAWINGS

FIG. 1 is a block diagram showing a network environment including an electronic device according to various embodiments of the disclosure.

FIG. 2 is a block diagram of an electronic device according to various embodiments of the disclosure.

FIG. 3 is a block diagram of a program module according to various embodiments of the disclosure.

FIG. 4 is a diagram schematically showing the configuration of a system providing address information related to delivery according to various embodiments of the disclosure.

FIG. 5 is a flowchart regarding a method of providing various pieces of address information related to the delivery of an electronic device according to various embodiments of the disclosure.

FIG. 6 is a flowchart regarding a method of providing various pieces of address information related to delivery using the server of an electronic device according to various embodiments of the disclosure.

FIG. 7 is a flowchart regarding a method of providing various pieces of address information related to delivery using the server of an electronic device according to various embodiments of the disclosure.

FIG. 8 is a diagram showing operations between an electronic device, a payment service server and a merchant server for providing various pieces of address information related to delivery according to various embodiments of the disclosure.

FIG. 9 is a diagram showing operations between an electronic device, a payment service server and a financial server for providing various pieces of address information related to delivery according to various embodiments of the disclosure.

FIG. 10 is a diagram showing operations between an electronic device, a payment service server and a user information analysis server for providing various pieces of address information related to delivery according to various embodiments of the disclosure.

FIG. 11 is a diagram showing a method of providing a user with various pieces of address information related to delivery through an electronic device and user interfaces displaying the method according to various embodiments of the disclosure.

FIG. 12A is a diagram showing an example in which an electronic device displays information on the schedule of a user according to various embodiments of the disclosure. FIG. 12B is a diagram showing a method for an electronic device to provide a user with various pieces of address information related to delivery using information on the schedule of the user and user interfaces displaying the method according to various embodiments of the disclosure.

### MODE FOR THE INVENTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. In the present disclosure, the expression “A or B”, “at least one of A or/and B”, or “one or more of A or/and B” may include all possible combinations of the items listed. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure. It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

In this document, “configured (or set) to ˜” may be interchangeably used with ‘suitable for ˜” in hardware or software, “having the capacity to ˜”, “adapted to ˜”, “made to ˜”, “capable of ˜”, or “designed to ˜” according to circumstances. In some circumstances, an expression “device configured to ˜” may mean that the device “may perform ˜” along with other devices or parts. For example, a phrase “processor configured (or set) to perform A, B and C” may mean a dedicated processor (e.g., an embedded processor) for performing a corresponding operation or a generic-purpose processor (e.g., a CPU or an application processor) capable of performing corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit). According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.). According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology. Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

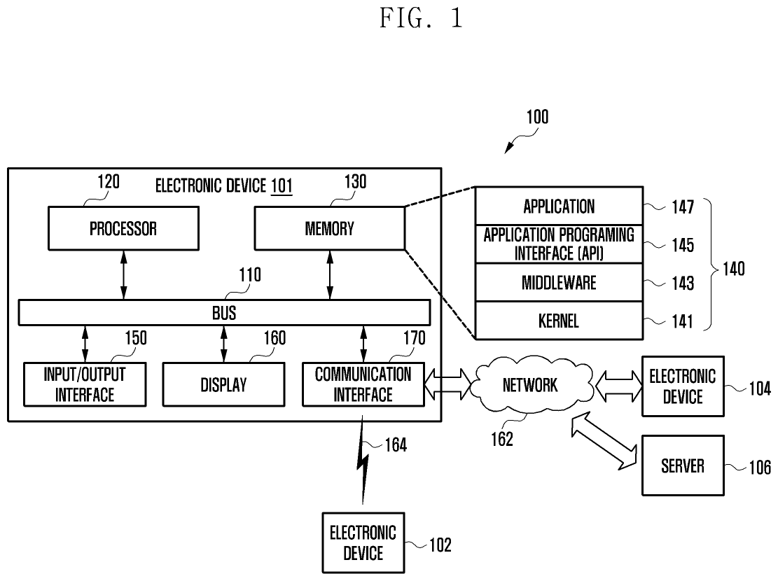

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components. The bus 110 may include, for example, a circuit which interconnects the components 110 to 170 and delivers a communication (e.g., a control message and/or data) between the components 110 to 170. The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS). The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data. Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto. The API 145 is an interface through which the applications 147 control functions provided from the kernel 141 or the middleware 143, and may include, for example, at least one interface or function (e.g., instruction) for file control, window control, image processing, character control, and the like. The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of wireless fidelity (WiFI), Bluetooth, Bluetooth low energy (BLE), Zigbee, near field communication (NFC), magnetic secure transmission, a radio frequency or a body area network (BAN), for example. According to one embodiment, the wireless communication may include Global Navigation Satellite System (GNSS). The GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

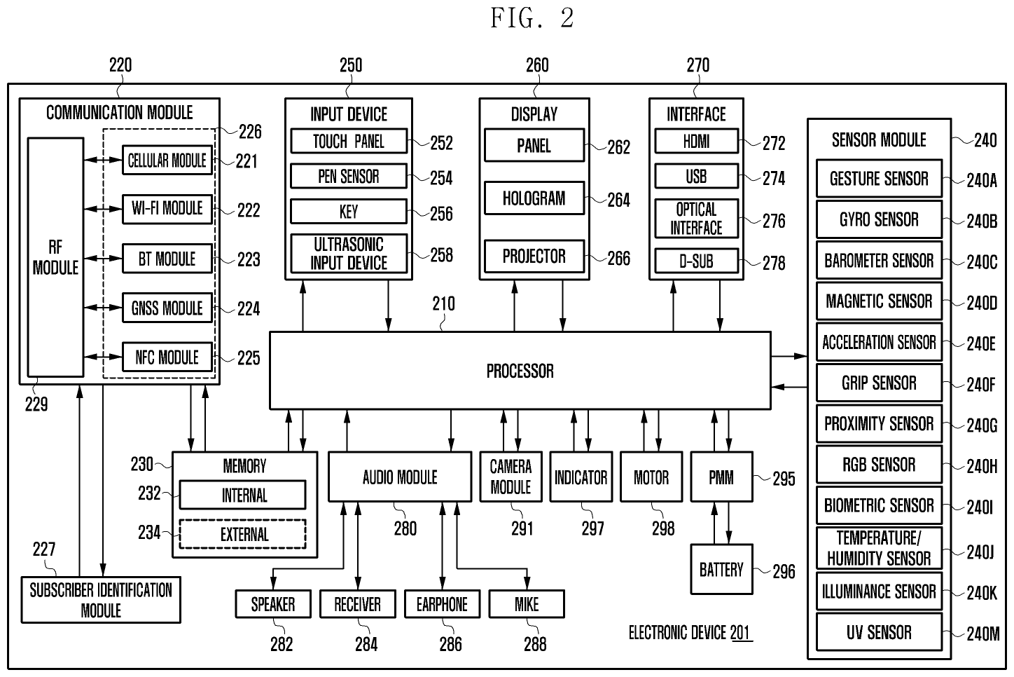

FIG. 2 is a block diagram of an electronic device according to various embodiments of the present disclosure. The electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298. The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 222, a BT module 223, a GNSS module 224, an NFC module 225, and a Radio Frequency (RF) module 229. The cellular module 221, for example, may provide a voice call, a video call, a text message service, or an Internet service through a communication network. According to one embodiment, the cellular module 221 may perform the identification and authentication of the electronic device 201 within a communication network using a subscriber identity module (e.g., SIM card) 227. According to one embodiment, the cellular module 221 may perform at least some of functions which may be provided by the processor 210. According to one embodiment, the cellular module 221 may include a communication processor (CP). According to an embodiment, at least some (e.g., two or more) of the cellular module 221, the WiFi module 222, the Bluetooth module 223, the GNSS module 224 or the NFC module 225 may be included in one integrated chip (IC) or IC package. The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the WIFI module 222, the BT module 223, the GNSS module 224, and the NFC module 225 may transmit/receive an RF signal through a separate RF module. The subscriber identification module 227 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

Meanwhile, the user information acquisition module 226 may include the cellular module 221, the WiFi module 222, the Bluetooth module 223, the GNSS module 224 and/or the NFC module 225, for example.

According to various embodiments, the user information acquisition module 226 may obtain information related to a user, for example. For example, the cellular module 221 may obtain information (e.g., calling number) related to a voice call, for example. Furthermore, for example, the cellular module 221 may obtain information (e.g., text information, a calling number, etc. included in a text message) related to a text service function, for example. The WiFi module 222 may obtain the Internet protocol (IP) address of at least one external device (e.g., access point (AP)) communicating with the electronic device 201, for example. The Bluetooth module 223 may obtain the identification (ID) of at least one external device (e.g., beacon using Bluetooth low energy (BLE)) communicating with the electronic device 201, for example. The GPS module 224 may obtain information on the location of the electronic device 201, for example, through a GPS function.

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like). The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user. The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266. The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288. The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp). The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™. Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

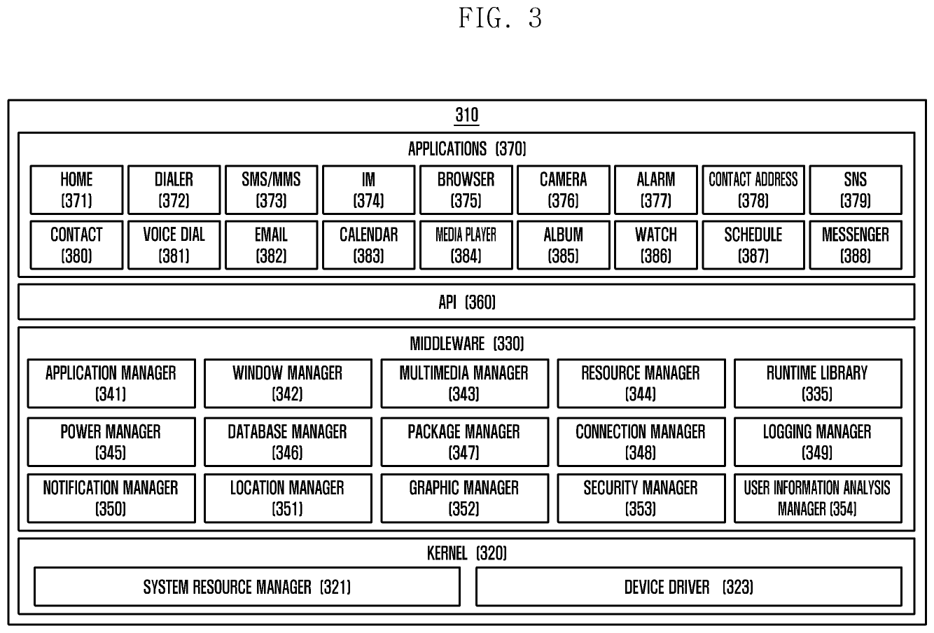

FIG. 3 is a block diagram of a program module according to various embodiments of the present disclosure. According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android™, iOS™, Windows™, Symbian™, Tizen™, Bada™, or the like. The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to one embodiment, the middle ware 330 may include at least one of a runtime library 335, an application manager 341, a window manager 342, a multimedia manager 343, a resource manager 344, a power manager 345, a database manager 346, a package manager 347, a connectivity manager 348, a logging manager 349, a notification manager 350, a location manager 351, a graphic manager 352, a security manager 353 or a user information analysis manager 354.

The runtime library 335 may include a library module that a compiler uses in order to add a new function through a programming language while an application 370 is being executed. The runtime library 335 may perform input/output management, memory management, the functionality for an arithmetic function, or the like. The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370. The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

The logging manager 349 may manage the storage function of information related to a user, obtained from an electronic device. For example, the logging manager 349 may store a calling number, obtained by a cellular module (not shown) (e.g., cellular module 221), in memory (not shown) (e.g., memory 130). For example, the logging manager 349 may store a text message, obtained by the cellular module, in the memory. For example, the logging manager 349 may store the Internet protocol address of an external device (e.g., AP), obtained by a WiFi module (not shown) (e.g., WiFi module 223), in the memory. For example, the logging manager 349 may store the identification of an external device (e.g., beacon), obtained by a Bluetooth module (not shown) (e.g., Bluetooth module 225), in the memory. For example, the logging manager 349 may store information on the location of an electronic device, obtained by a GNSS module (not shown) (e.g., GNSS module 227) through a GPS function, in the memory.

According to various embodiments, the logging manager 349 may manage a function for obtaining and storing information related to a user, for example, from the application 370 using the API 360. For example, the logging manager 349 may obtain contact address information (e.g., telephone number, birthday, home address), stored in an electronic device, from the contact address application 378, and may store the obtained contact address information in the memory. For example, the logging manager 349 may obtain information (e.g., web page address, web page access time), related to the browser use of a user, from the browser application 375, and may store the obtained information related to the browser use in the memory. For example, the logging manager 349 may obtain information (e.g., text information related to writing posted on social networking service (SNS) by a user), related to the SNS use of a user, from an SNS application 379, and may store the obtained information related to the SNS use in the memory. For example, the logging manager 349 may obtain information, related to the schedule of a user, from the schedule application 387, and may store the obtained information related to the schedule in the memory. For example, the logging manager 349 may obtain information (e.g., text information included in e-mail) related to e-mail transmitted and received by the e-mail application 382, and may store the obtained information related to the e-mail in the memory. For example, the logging manager 349 may obtain information (e.g., text information included in a messenger message) transmitted and received by the messenger application 388, and may store the obtained information transmitted and received by the messenger application 388 in the memory. For example, the logging manager 349 may obtain information (e.g., address set by a user, an address most searched for by a user), related to an address, from the navigation application, and may store the obtained information related to the address in the memory.

The notification manager 350 may display or notify of an event such as an arrival message, promise, proximity notification, and the like in such a way that does not disturb a user. The location manager 351 may manage location information of an electronic device. The graphic manager 352 may manage a graphic effect which will be provided to a user, or a user interface related to the graphic effect. The security manager 353 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The user information analysis manager 354 may perform a function of analyzing information related to a user, for example. Furthermore, the user information analysis manager 354 may perform a function of obtaining information (e.g., product that a user wants to buy, a desired purchase date, information related to delivery) related to product purchase, for example, from information related to a user. In this case, the information related to a user may include information obtained by an electronic device when a user uses the electronic device, for example. The user information analysis manager 354 may obtain location information related to a user, for example, from information related to a user. The user information analysis manager 354 may obtain location information (e.g., home address, an office address), related to the user, using the Internet protocol address of an external device stored in the memory, identification and/or information on the location of the electronic device obtained through the GPS function, for example. For example, if an electronic device communicated with an external device (e.g., AP) positioned in a given building from 9 a.m. to 6 p.m. on weekdays and location information obtained by the electronic device through a GPS function is identical with location information of the given building, the user information analysis manager 354 may identify the given building as an office, a school, etc., and may analyze the address of the given building identified to be an office, a school, etc. as address information related to delivery.

For example, the user information analysis manager 354 may obtain information (e.g., product that a user wants to buy, a desired delivery date, address information related to delivery), related to product purchase, from text information (e.g., text message, text information related to writing posted on SNS, text information included in e-mail, text information included in a messenger message) stored in the memory using natural language processing (NLP). In this case, the natural language processing may include a technology for mechanically analyzing a human's language phenomenon, for example, so that an electronic device may recognize the meaning of the corresponding language phenomenon. For example, in the case of text information including “Mother's birthday is September 2 and I want to give a bag as a gift”, the user information analysis manager 354 may recognize the meaning of “Mother”, “Birthday”, “September”, “2”, “Bag”, “Gift”, and may obtain information related to product purchase using the meaning. Furthermore, the user information analysis manager 354 may analyze the bag as a purchase product, September 2 as a delivery date, and the mother as a product recipient, for example. Furthermore, the user information analysis manager 354 may identify information on a mother's home address in contact address information stored in the memory, for example, and may analyze the mother's home address as address information related to delivery.

According to various embodiments, the user information analysis manager 354 may manage a function of storing information (e.g., location information related to a user, information related to product purchase) obtained from information related to a user, for example. For example, the user information analysis manager 354 may store information (e.g., purchase product, a delivery date, a product recipient, address information related to delivery) related to product purchase in the memory.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components. The API 360 is, for example, a set of API programming functions, and may be provided with a different configuration according to an OS. For example, in the case of Android or iOS, one API set may be provided for each platform. In the case of Tizen, two or more API sets may be provided for each platform.

The application 370 may include a home 371, dialer 372, SMS/MMS 373, instant message (IM) 374, browser 375, camera 376, alarm 377, contact address 378, SNS 379, contact 380, voice dial 381, e-mail 382, diary 383, media player 384, album 385, watch 386, schedule 387, messenger 388 or health care (e.g., measurement of quantity of motion or blood sugar) application, for example. According to one embodiment, the application 370 may include an information exchange application capable of supporting an information exchange between an electronic device and an external electronic device. The information exchange application may include a notification relay application for delivering given information to an external electronic device or a device management application for managing an external electronic device, for example. For example, the notification relay application may deliver notification information, occurred in another application of an electronic device, to an external electronic device or may obtain notification information from an external electronic device and provide it to a user. The device management application may install, delete or update a function (e.g., the turn-on/turn-off of an external electronic device itself (or some elements) or brightness (or resolution) control of a display) of an external electronic device communicating with an electronic device or an application operating in an external electronic device, for example. According to one embodiment, the application 370 may include a designated application (e.g., health management application of a mobile medical device) based on the attributes of an external electronic device. According to one embodiment, the application 370 may include an application obtained from an external electronic device. At least some of the program module 310 may be implemented (e.g., executed) by software, firmware, hardware (e.g., processor 210) or a combination of two or more of them, and may include a module, program, routine, instruction set or process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130. The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa. Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

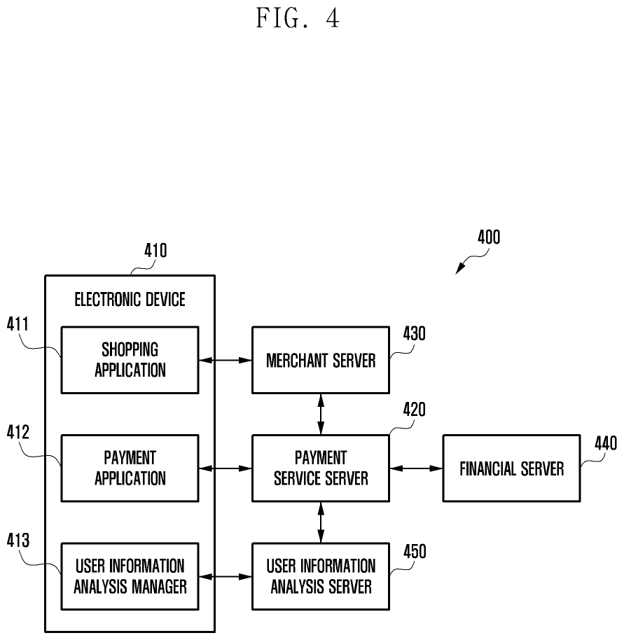

FIG. 4 is a diagram schematically showing the configuration of a system providing address information related to delivery according to various embodiments of the disclosure.

According to various embodiments, the system 400 providing address information related to delivery may include an electronic device 410 (e.g., electronic device 101) and/or at least one server (e.g., server 106). For example, the server may include at least one of a payment service server 420, a merchant server 430, a financial server 440 or a user information analysis server 450.

The electronic device 410 may include a shopping application 411, a payment application (wallet application) 412 and/or a user information analysis manager 413 (e.g., user information analysis manager 354), for example.

According to various embodiments, the shopping application 411 may provide a user interface (e.g., user interface (UI) or user experience (UX)) related to product purchase, for example. For example, the shopping application 411 may provide various user interfaces related to a product search, product selection or product purchase process. Furthermore, the shopping application 411 [symbol] may provide user interfaces related to account registration or log-in, for example.

Furthermore, according to various embodiments, the electronic device 410 may perform a product purchase function using the shopping application 411. For example, the shopping application 411 may provide a user with a function capable of purchasing a product in the state in which the merchant server 430 has been logged in or a function capable of purchasing a product using user account information managed by at least one external server (e.g., server providing SNS service). For example, the electronic device 410 may provide a user interface related to user authentication for a server (not shown) that provides an SNS service functionally connected to an SNS application (e.g., SNS application 379). In this case, when the electronic device 410 receives a user input for user authentication for the server providing the SNS service, the shopping application 411 may provide a user with a function capable of purchasing a product using user account information managed by the server providing the SNS service. A user may be provided with a product purchase function using the shopping application 411 and may be provided with information related to a product by the electronic device 410.

According to various embodiments, the payment application 412 may include a payment application (e.g., Samsung Pay Application), for example. The payment application 412 may provide a user interface related to payment, for example. The user interface related to payment may include a wallet user interface (wallet UI/UX), for example. For example, the payment application 412 may provide a user interface related to card registration, payment or transactions. The payment application 412 may provide an interface related to card registration through a text reader (e.g., optical character reader/recognition (OCR)) or an external input (e.g., user input), for example. Furthermore, the payment application 412 may provide an interface related to user authentication through identification & verification (ID&V), for example.

According to various embodiments, the electronic device 410 may perform payment transactions using the payment application 412. For example, the payment application 412 may provide a user with a payment function through the execution of Simple Pay, Quick Pay or a designated application from which at least some of functions included in the application is omitted. A user may perform the payment function using the payment application 412, and may be provided with information associated with the payment function by the electronic device 410.

According to various embodiments, the user information analysis manager 413 may perform a function of analyzing information related to a user, for example. The user information analysis manager 413 may perform a function of obtaining information (e.g., product that a user wants to buy, a desired purchase date, information related to delivery) related to product purchase, for example, from information related to a user.

According to various embodiments, the user information analysis manager 413 may analyze information related to a user using big data, for example, and may obtain information, related to product purchase, from the information related to the user. In this case, the big data means a set of a large amount of data, and may also mean a technology capable of performing analysis using a large amount of data, obtaining valuable data, and actively handling a change or predicting a change based on obtained data.

According to various embodiments, the user information analysis manager 413 may analyze information related to a user using a machine learning technology, for example, and may obtain information related to product purchase from the information related to the user. In this case, the machine learning is one field of artificial intelligence, and may mean a technology for researching and constructing a system through which an electronic device can analyze and learn data based on a learning model and improve its analysis and learning performance based on the analyzed and trained results and an algorithm for the system. Furthermore, the machine learning may include a deep learning technology, that is, a set of algorithms that summarize core contents or function in a large amount of data based on a human's cranial nerves cell, a neural network that is an electronic circuit network structure simulated from a combination structure thereof, and a neural network of a multi-layered structure form.

According to various embodiments, the payment service server 420 may manage a service account (e.g., Samsung account) or a user account, for example, and may manage card information related to the service account or user account. Furthermore, the payment service server 420 may include an application program interface (API) server (not shown) related to the payment application 412. Furthermore, the payment service server 420 may provide an account management module (e.g., account integration or Samsung account integration), for example. Furthermore, the payment service server 420 may communicate with at least one of the merchant server 430, the financial server 440 or the user information analysis server 450, for example, and may transmit and receive information (e.g., address information related to delivery). Furthermore, the payment service server 420 may manage information (e.g., information on whether a server can transmit and receive mutual information, information on a correspondence relationship between card information managed by the payment service server 420 and the financial server 440) on at least one of the merchant server 430, the financial server 440 or the user information analysis server 450, for example.

According to various embodiments, the payment application 412 and the payment service server 420 included in the electronic device 410 may be functionally connected. The payment application 412 may transmit and receive information related to payment, for example, to and from the payment service server 420. Furthermore, the payment application 412 may transmit and receive address information related to delivery, for example, to and from the payment service server 420. Furthermore, the payment service server 420 may manage address information related to delivery, for example. For example, when address information related to delivery is requested by the payment application 412 included in the electronic device 410, the payment service server 420 may generate or store a destination list. Furthermore, the payment service server 420 may transmit the generated destination list to the payment application 412, for example.

According to various embodiments, the merchant server 430 may manage information related to a product. Furthermore, the product server 430 may include an API server (not shown) related to the shopping application 411, for example. Furthermore, the product server 430 may manage a user account, for example, and may store information (e.g., purchase history, information related to delivery) related to a user account. Furthermore, the product server 430 may include the software development kit (SDK) of the payment service server 420, for example. For example, the product server 430 may include a web site, web application, etc. using the SDK of the payment service server 420. In this case, the payment service server 420 may identify information (e.g., whether a user has been logged in, whether the account of a user has been registered) using the API of an SDK related to the product server 430, for example.

According to various embodiments, the shopping application 411 and the merchant server 430 included in the electronic device 410 may be functionally connected. The shopping application 411 may transmit and receive information (e.g., product identification, purchase quantity, payment information) related to product purchase, for example, to and from the merchant server 430. Furthermore, the shopping application 411 may transmit and receive information related to a user account, for example, to and from the merchant server 430.

According to various embodiments, the financial server 440 may manage a user account, for example, and may store information (e.g., account information, card information, a billing address) related to a user account. Furthermore, the financial server 440 may transmit and receive information (e.g., card information, a billing address) related to a user account, for example, to and from the payment service server 420.

The user information analysis server 450 according to various embodiments may be functionally connected to the user information analysis manager 413 included in the electronic device 410. For example, the user information analysis server 450 may transmit and receive, to and from the user information analysis manager 413, information related to a user. Furthermore, the user information analysis server 450 may manage a user account, for example, and may manage information related to a user. For example, the user information analysis server 450 may perform a function of analyzing information related to a user, and may perform a function of obtaining information (e.g., product that a user wants to buy, a desired purchase date, address information related to delivery) related to product purchase by analyzing information related to a user. Furthermore, the user information analysis server 450 may transmit and receive the obtained information related to the product purchase to and from the payment service server 420, for example.

In this case, the user information analysis server 450 may perform a function identical with or similar to the function of the user information analysis manager 413 for analyzing information related to a user, for example. Furthermore, the user information analysis server 450 may perform a function identical with or similar to the function of the user information analysis manager 413 for obtaining information related to product purchase, for example, from information related to a user.

According to various embodiments, the payment service server 420 and/or the user information analysis server 450 may be positioned in the same or similar areas or may be positioned in separated areas. For example, the payment service server 420 may be included in a first server, and the user information analysis server 450 may be included in a second server. Furthermore, for example, the payment service server 420 and/or the user information analysis server 450 may be divided and implemented in one server (e.g., first server or second server).

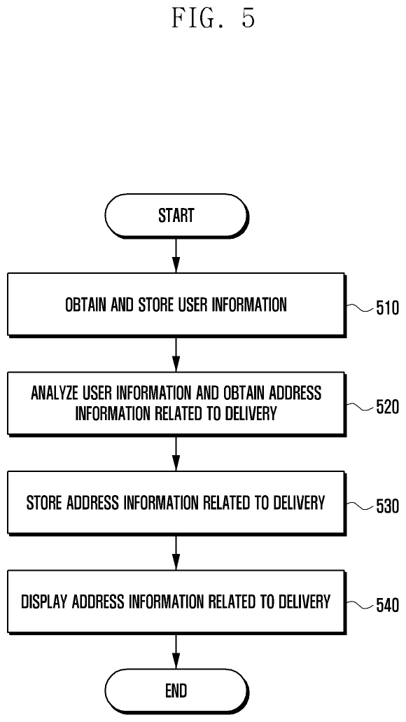

FIG. 5 is a flowchart regarding a method of providing various pieces of address information related to the delivery of an electronic device according to various embodiments of the disclosure.

According to various embodiments, an electronic device (e.g., electronic device 101) may obtain and store information related to a user at operation 510. According to various embodiments, the electronic device may obtain information related to a user through a user information acquisition module (e.g., user information acquisition module 226), for example. For example, the electronic device may obtain information (e.g., calling number) related to a voice call through a cellular module (e.g., cellular module 221). For example, the electronic device may obtain information (e.g., text, a calling number, etc. included in a text message) related to a text service function through a cellular module (e.g., cellular module 221). For example, the electronic device may obtain the Internet protocol address of at least one external device (e.g., access point (AP)) communicating with the electronic device through a WiFi module (e.g., WiFi module 222). For example, the electronic device may obtain the identification of at least one external device (e.g., beacon using LE Bluetooth) communicating with the electronic device through a Bluetooth module (e.g., Bluetooth module 223). For example, the electronic device may obtain information on the location of the electronic device through the GPS function of a GPS module (e.g., GPS module 224).

According to various embodiments, the electronic device may store information related to a user, obtained through a logging manager (e.g., logging manager 349) included in a program module (e.g., program module 310), for example. For example, the electronic device may store information related to a voice call, obtained through the cellular module, in memory (e.g., memory 130). For example, the electronic device may store information related to a text service function, obtained through the cellular module, in the memory. For example, the electronic device may store the Internet protocol address of at least one external device communicating with the electronic device, obtained through the WiFi module, in the memory. For example, the electronic device may store the identification of at least one external device communicating with the electronic device, obtained through the Bluetooth module, in the memory. For example, the electronic device may store information on the location of the electronic device, obtained through the GPS module, in the memory.

According to various embodiments, the electronic device may obtain information related to a user from an application (e.g., application 370) through the logging manager included in the program module, for example, and may store the obtained information. For example, the electronic device may obtain stored contact address information (e.g., telephone number, birthday, home address) from a contact address application (e.g., contact address application 378), and may store the obtained contact address information in the memory. For example, the electronic device may obtain information (e.g., web page address, web page access time), related to the browser use of a user, from a browser application (e.g., browser application 375), and may store the obtained information related to the browser use in the memory. For example, the electronic device may obtain information (e.g., text related to writing posted on SNS by a user), related to the SNS use of a user, from an SNS application (e.g., SNS application 379), and may store the obtained information related to the SNS use in the memory. For example, the electronic device may obtain information related to the schedule of a user from a schedule application (e.g., schedule application 387), and may store the obtained information related to the schedule in the memory. For example, the electronic device may obtain information (e.g., text included in e-mail) related to e-mail transmitted and received by an e-mail application (e.g., e-mail application 382), and may store the obtained information related to the e-mail in the memory. For example, the electronic device may obtain information (e.g., text included in a messenger message) transmitted and received by a messenger application (e.g., messenger application 388), and may store the obtained transmission and reception information in the memory. For example, the electronic device may obtain information (e.g., address set by a user, an address most searched for by a user), related to an address, from a navigation application, and may store the obtained information related to the address in the memory.

According to various embodiments, at operation 520, the electronic device may analyze the stored information related to the user, and may obtain address information related to delivery from the information related to the user. According to various embodiments, the electronic device may analyze information related to a user through a user information analysis manager (e.g., user information analysis manager 354) included in a program module, for example. Furthermore, the electronic device may obtain information (e.g., product that a user wants to buy, a desired purchase date, information related to delivery) related to product purchase, for example, from information related to a user.

According to various embodiments, the electronic device may obtain location information related to a user, for example, from information related to the user. For example, the electronic device may obtain location information (e.g., home address, an office address) related to a user using the Internet protocol address of an external device stored in memory, identification and/or information on the location of the electronic device obtained through a GPS function. If an electronic device communicates with an external device (e.g., AP) positioned in a given building from 9 a.m. to 6 p.m. on weekdays and location information obtained by the electronic device through a GPS function is identical with information on the location of a given building, the electronic device may identify the given building as an office, a school, etc., and may analyze the address of the given building determined to be an office, a school, etc. as address information related to delivery.

According to various embodiments, the electronic device may obtain information (e.g., product that a user wants to buy, a desired delivery date, address information related to delivery), related to product purchase, from text (e.g., text message, text related to writing posted on SNS, text included in e-mail, text included in a messenger message) stored in the memory using natural language processing. For example, in the case of text including “Mother's birthday is September 2 and I want to give a bag as a gift”, the electronic device may recognize the meaning of “Mother”, “Birthday”, “September”, “2”, “Bag”, “Gift”, and may obtain information related to product purchase using the meaning. Furthermore, the electronic device may analyze the bag as a purchase product, September 2 as a delivery date, and the mother as a product recipient, for example. Furthermore, the electronic device may identify information on a mother's home address in contact address information stored in the memory, for example, and may identify the mother's home address as address information related to delivery.

According to various embodiments, the electronic device may store address information related to delivery, extracted from the information related to the user, at operation 530. For example, the electronic device may store information (e.g., purchase product, a delivery date, a product recipient, address information related to delivery) related to product purchase, extracted from the information related to the user, in the memory.

According to various embodiments, the electronic device may display the obtained address information related to delivery on a display (e.g., display 160) at operation 540.

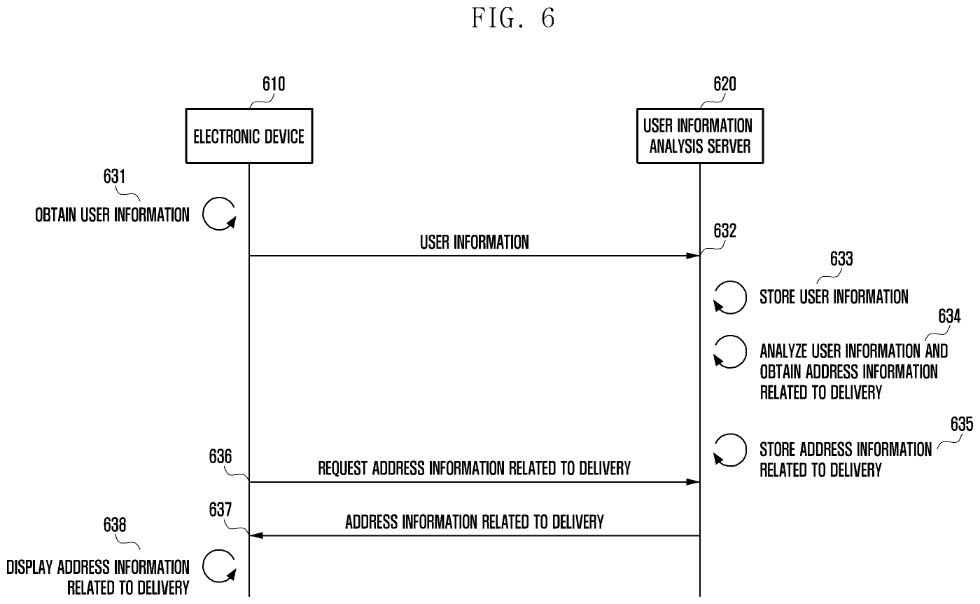

FIG. 6 is a flowchart regarding a method of providing various pieces of address information related to delivery using the server of an electronic device according to various embodiments of the disclosure. A detailed description of contents identical with the contents described in FIG. 5 is omitted.

According to various embodiments, an electronic device 610 (e.g., electronic device 101) may obtain information related to a user at operation 631.

According to various embodiments, the electronic device 610 may transmit the obtained information related to the user to a user information analysis server 620 (e.g., user information analysis server 450) at operation 632.

According to various embodiments, the user information analysis server 620 may store the information related to the user, received from the electronic device 610, at operation 633. According to various embodiments, the user information analysis server 620 may omit the execution of operation 633.

According to various embodiments, the user information analysis server 620 may analyze the information related to the user at operation 634. Furthermore, the user information analysis server 620 may obtain address information related to delivery, for example, from the information related to the user.

According to various embodiments, the user information analysis server 620 may store the obtained address information related to delivery at operation 635.

According to various embodiments, the electronic device 610 may request address information related to delivery from the user information analysis server 620 at operation 636.

According to various embodiments, the user information analysis server 620 may transmit the address information related to delivery to the electronic device 610 at operation 637.

According to various embodiments, the electronic device 610 may display the address information related to delivery, received from the user information analysis server 620, at operation 638.

Accordingly, according to various embodiments, when a user purchases a product through an electronic device, the electronic device can provide the user with various pieces of address information related to delivery using the obtained information related to the user.

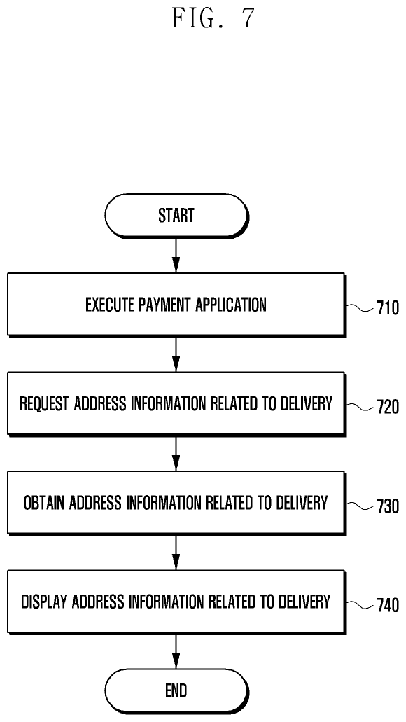

FIG. 7 is a flowchart regarding a method of providing various pieces of address information related to delivery using the server of an electronic device according to various embodiments of the disclosure.

According to various embodiments, an electronic device (e.g., electronic device 410) may execute an application (e.g., payment application 412) capable of performing a payment function at operation 710. For example, a user may purchase a product through an application (e.g., shopping application 411) that provides a user interface related to product purchase. In this case, the electronic device may execute the payment application 412 based on a received user input for product purchase, for example.

According to various embodiments, the electronic device may request address information related to delivery from an external device (e.g., payment service server 420) at operation 720. For example, the electronic device may request the address information related to delivery from the payment service server 420, functionally connected to the payment application 412, through the payment application 412.

According to various embodiments, the electronic device may obtain the address information related to delivery from the external device at operation 730. For example, the electronic device may receive the address information related to delivery from the payment service server 420, functionally connected to the payment application 412, through the payment application 412.

According to various embodiments, the electronic device may display the address information related to delivery, received from the external device, on a display (e.g., display 160) at operation 740.

Accordingly, according to various embodiments, when a user purchases a product through an electronic device, the electronic device can provide the user with various pieces of address information related to delivery using an external device.

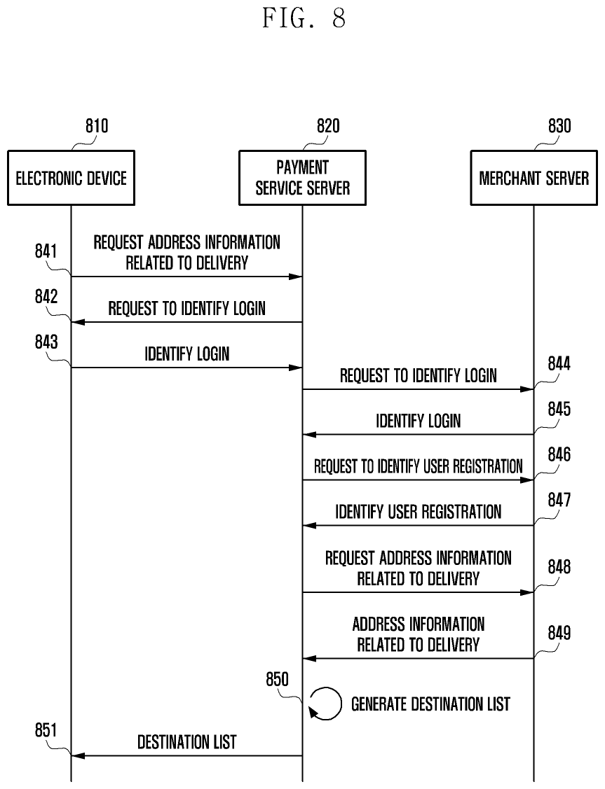

FIG. 8 is a diagram showing operations between an electronic device, a payment service server and a merchant server for providing various pieces of address information related to delivery according to various embodiments of the disclosure.

According to various embodiments, an electronic device 810 (e.g., electronic device 410) may request address information related to delivery from a payment service server 820 (e.g., payment service server 420) at operation 841. For example, the electronic device 810 may request the address information related to delivery from the payment service server 820, functionally connected to an application (e.g., payment application 412) capable of performing a payment function, through the payment application 412.

Meanwhile, the electronic device 810 may transmit information (e.g., information on a merchant server related to a corresponding product) related to a product that a user wants to buy, for example, to the payment service server 820 along with the address information related to delivery.

The electronic device 810 may identify whether the electronic device 810 has logged in to the payment service server 820 through the payment application 412, for example. If the electronic device 810 has logged in to the payment service server 820, it may request address information related to delivery from the payment service server 820. Furthermore, for example, if the electronic device 810 has not logged in to the payment service server 820, the electronic device 810 may provide an interface related to user authentication through identification & verification (ID&V). In this case, if the electronic device 810 has obtained a user input (e.g., fingerprint recognition, iris recognition, account information input) for identification & verification and thus user authentication has been completed, the electronic device 810 may log in to the payment service server 820 through the payment application 412, and may request address information related to delivery from the payment service server 820.

According to various embodiments, the payment service server 820 may request the electronic device 810 to identify whether the electronic device 810 has logged in to a merchant server 830 (e.g., merchant server 430) at operation 842.

According to various embodiments, when a request to identify whether the electronic device 810 has logged in to the merchant server 830 is received from the payment service server 820, the electronic device 810 may identify whether it has logged in to the merchant server 830 at operation 843, and may transmit a result of the identification to the payment service server 820. For example, the electronic device 810 may identify whether it has logged in to the merchant server 830 through an application (e.g., shopping application 411) that provides a user interface related to product purchase.

According to various embodiments, the payment service server 820 may request the merchant server 830 to identify whether the electronic device 810 has logged in to the merchant server 830 at operation 844.

According to various embodiments, when a request to identify whether the electronic device 810 has logged in to the merchant server 830 is received from the payment service server 820, the merchant server 830 may identify whether the electronic device 810 has logged in to the merchant server 830, and may transmit a result of the identification to the payment service server 820 at operation 845. According to various embodiments, the merchant server 830 may include a web site, a web application, etc. using the software development kit (SDK) of the payment service server 820, for example. In this case, the payment service server 820 may identify whether the electronic device 810 has logged in to the merchant server 830 using the API of an SDK related to the product server 830 through communication with the product server 830.

According to various embodiments, order that operation 842 and operation 844 are performed may be various. For example, operation 842 may be first performed, and operation 844 may be then performed. Alternatively, for example, operation 844 may be first performed, and operation 842 may be then performed. Alternatively, for example, operation 842 and operation 842 may be performed at the same time.

The payment service server 820 may perform only any one of operation 842 and operation 844, for example. For example, if the payment service server 820 has identified whether the electronic device 810 has logged in to the merchant server 830 by performing operation 842 and operation 843, it may omit operation 844 and operation 845.

According to various embodiments, the payment service server 820 may request the merchant server 830 to identify whether the account of a user has been registered with the merchant server 830 at operation 846. According to various embodiments, if it is identified that the electronic device 810 has logged in to the merchant server 830, the payment service server 820 may omit operation 846.

According to various embodiments, the merchant server 830 may identify whether the account of the user has been registered with the merchant server 830 at operation 847, and may transmit a result of the identification to the payment service server 820. According to various embodiments, the merchant server 830 may include a web site, a web application, etc. using the SDK of the payment service server 820, for example. In this case, the payment service server 820 may identify whether the account of the user has been registered with the merchant server 830 using the API of an SDK related to the product server 830 through communication with the product server 830.

According to various embodiments, for example, in the case of Korea, the payment service server 820 may transmit connecting information (CI) to the merchant server 830. In this case, if a user has his or her account registered with two or more services using different authentication information (e.g., resident registration number, i-pin), the connecting information may mean information to identify whether the users registered with the two or more services are the same. In this case, the merchant server 830 may identify whether the account of the user has been registered based on connecting information obtained from the payment service server 820, and may transmit a result of the identification to the payment service server 820.

According to various embodiments, the payment service server 820 may request the address information related to delivery from the merchant server 830 at operation 848. For example, if the case corresponds to at least one of a case where it is identified that the electronic device 810 has logged in to the merchant server 830 and a case where it is identified that the account of the user has been registered with the merchant server 830, the payment service server 820 may request the address information related to delivery from the merchant server 830.

According to various embodiments, the merchant server 830 may transmit the address information related to delivery to the payment service server 820 at operation 849. For example, the merchant server 830 may transmit, to the payment service server 820, address information (e.g., home address, office address of a user registered with an account, destination information previously used by a user) related to delivery, which is included in information (e.g., information registered with an account, the purchase history of a user, information related to delivery) related to the user account.

According to various embodiments, the payment service server 820 may generate a destination list at operation 850. The payment service server 820 may store the generated destination list, for example. For example, the payment service server 820 may obtain address information from a service account (e.g., Samsung account) or user account managed by the payment service server 820, and may add the obtained address information (e.g., home address, office address) to the destination list. Furthermore, the payment service server 820 may add address information related to delivery, obtained from the merchant server 830, to the destination list, for example.

The payment service server 820 may obtain information related to a product that a user wants to buy, for example, along with a request for address information related to delivery from the electronic device 810 at operation 841. In this case, when the corresponding information related to the product, received from the payment service server 820, is not identical with information (e.g., information on whether a server can transmit and receive mutual information) on the merchant server 830 managed by the payment service server 820, operation 842 to operation 849 may be omitted.

According to various embodiments, if a destination list is to be generated, the payment service server 820 may determine order of address information included in the destination list. For example, the payment service server 820 may obtain address information on the place where a product is delivered from the electronic device 810 and/or the merchant server 830, and may determine order of address information included in a destination list based on distance information between the address of the place where the product is delivered and an address included in the destination list. Furthermore, the payment service server 820 may obtain additional information (e.g., delivery details, time taken for delivery) related to delivery, for example, from the product server 830, and may determine order of address information included in a destination list based on the received additional information related to delivery.

According to various embodiments, the payment service server 820 may transmit the destination list to the electronic device 810 at operation 851.

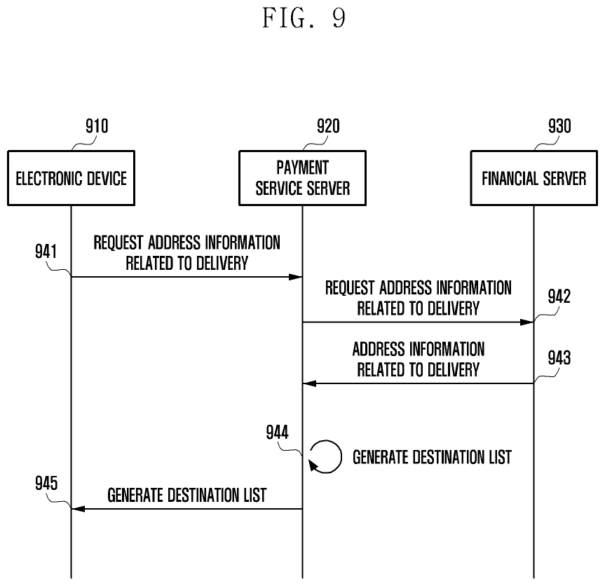

FIG. 9 is a diagram showing operations between an electronic device, a payment service server and a financial server for providing various pieces of address information related to delivery according to various embodiments of the disclosure. A detailed description of contents identical with the contents described in FIG. 8 is omitted.

According to various embodiments, an electronic device 910 (e.g., electronic device 410) may request address information related to delivery from a payment service server 920 (e.g., payment service server 420) at operation 941. For example, the electronic device 910 may request the address information related to delivery from the payment service server 920, functionally connected to an application (e.g., payment application 412) capable of performing a payment function, through the payment application 412. Furthermore, the electronic device 910 may transmit information (e.g., card information) related to payment means selected by a user for product purchase, for example, to the payment service server 920.

According to various embodiments, the payment service server 920 may request the address information related to delivery from a financial server 930 (e.g., financial server 440) at operation 942. For example, the payment service server 920 may identify card information related to a service account (e.g., Samsung account) or a user account, and may request the address information related to delivery from the financial server 930 related to the identified card information.

When card information selected by a user for product purchase is obtained from the electronic device 910, for example, the payment service server 920 may compare the obtained card information with card information related to a service account or a user account. In this case, for example, when the obtained card information is not identical with the card information related to the service account or the user account, the payment service server 920 may omit a request for address information related to delivery with respect to the financial server 930.

According to various embodiments, the financial server 930 may transmit the address information related to delivery to the payment service server 820 at operation 943. For example, the financial server 930 may transmit, to the payment service server 920, address information (e.g., home address, office address, billing address, etc. of a user registered with an account) related to delivery, which is included in information (e.g., account information, card information, billing address) related to a user account.

According to various embodiments, the payment service server 920 may generate a destination list at operation 944. The payment service server 920 may store the generated destination list, for example. For example, the payment service server 920 may obtain address information from a service account (e.g., Samsung account) or user account managed by the payment service server 920, and may add the obtained address information (e.g., home address, an office address) to the destination list. Furthermore, the payment service server 920 may add address information related to delivery, obtained from the financial server 930, for example, to the destination list.

According to various embodiments, if a destination list is to be generated, the payment service server 920 may determine order of address information included in the destination list.

According to various embodiments, the payment service server 920 may transmit the destination list to the electronic device 910 at operation 945.

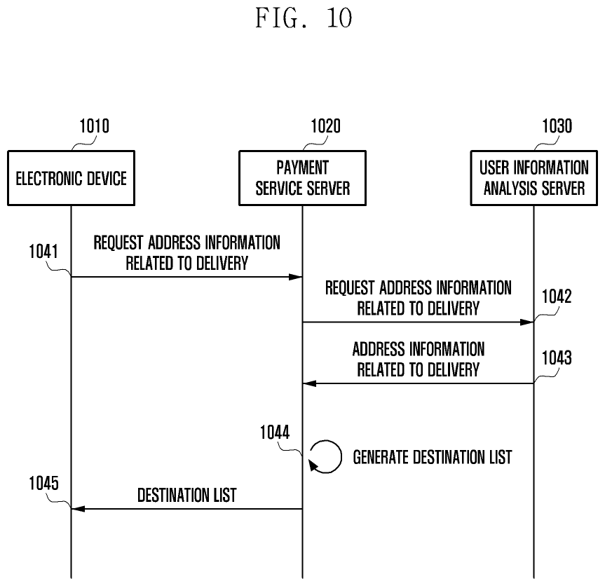

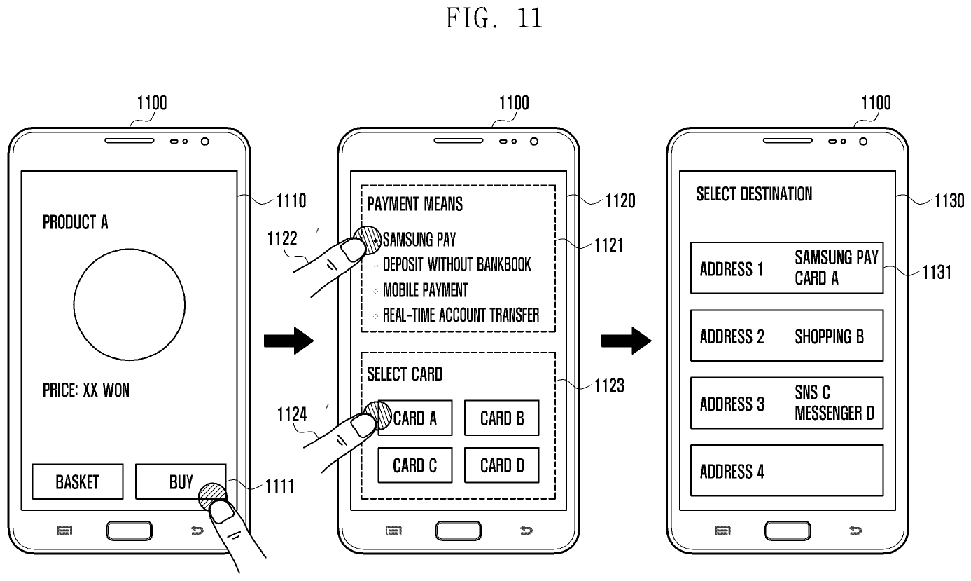

FIG. 10 is a diagram showing operations between an electronic device, a payment service server and a user information analysis server for providing various pieces of address information related to delivery according to various embodiments of the disclosure. A detailed description of contents identical with the contents described in FIG. 8 is omitted.

According to various embodiments, an electronic device 1010 (e.g., electronic device 410) may request address information related to delivery from a payment service server 1020 (e.g., payment service server 420) at operation 1041. For example, the electronic device 1010 may request the address information related to delivery from the payment service server 1020, functionally connected to an application (e.g., payment application 412) capable of performing a payment function, through the payment application 412.

According to various embodiments, the payment service server 1020 may request the address information related to delivery from a user information analysis server 1030 (e.g., user information analysis server 450) at operation 1042.

According to various embodiments, the user information analysis server 1030 may transmit the address information related to delivery to the payment service server 820 at operation 1043. For example, the user information analysis server 1030 may transmit address information related to delivery, obtained by analyzing information related to the user of the electronic device 1010, to the payment service server 1010.

According to various embodiments, the payment service server 1020 may generate a destination list. The payment service server 1020 may store the generated destination list, for example, at operation 1044. For example, the payment service server 1020 may obtain address information from a service account (e.g., Samsung account) or user account managed by the payment service server 1020, and may add the obtained address information (e.g., home address, office address) to the destination list. Furthermore, the payment service server 1020 may add address information related to delivery, received from the user information analysis server 1030, for example, to the destination list.

According to various embodiments, if a destination list is to be generated, the payment service server 1020 may determine order of address information included in the destination list.

According to various embodiments, the payment service server 1020 may transmit the destination list to the electronic device 1010 at operation 1045.

According to various embodiments, the payment service server 1020 and/or the user information analysis server 1030 may be positioned in the same or similar areas or may be positioned in separated areas. For example, the payment service server 1020 may be included in a first server, and the user information analysis server 1030 may be included in a second server. Furthermore, for example, the payment service server 1020 and/or the user information analysis server 1030 may be divided and implemented in one server (e.g., first server or second server).

FIG. 10 is a diagram showing operations between an electronic device, a payment service server and a user information analysis server for providing various pieces of address information related to delivery according to various embodiments of the disclosure. A detailed description of contents identical with the contents described in FIG. 8 is omitted.

According to various embodiments, an electronic device 1010 (e.g., electronic device 410) may request address information related to delivery from a payment service server 1020 (e.g., payment service server 420) at operation 1041. For example, the electronic device 1010 may request the address information related to delivery from the payment service server 1020, functionally connected to an application (e.g., payment application 412) capable of performing a payment function, through the payment application 412.

According to various embodiments, the payment service server 1020 may request the address information related to delivery from a user information analysis server 1030 (e.g., user information analysis server 450) at operation 1042.

According to various embodiments, the user information analysis server 1030 may transmit the address information related to delivery to the payment service server 820 at operation 1043. For example, the user information analysis server 1030 may transmit address information related to delivery, obtained by analyzing information related to the user of the electronic device 1010, to the payment service server 1010.

According to various embodiments, the payment service server 1020 may generate a destination list. The payment service server 1020 may store the generated destination list, for example, at operation 1044. For example, the payment service server 1020 may obtain address information from a service account (e.g., Samsung account) or user account managed by the payment service server 1020, and may add the obtained address information (e.g., home address, office address) to the destination list. Furthermore, the payment service server 1020 may add address information related to delivery, received from the user information analysis server 1030, for example, to the destination list.

According to various embodiments, if a destination list is to be generated, the payment service server 1020 may determine order of address information included in the destination list.

According to various embodiments, the payment service server 1020 may transmit the destination list to the electronic device 1010 at operation 1045.

According to various embodiments, the payment service server 1020 and/or the user information analysis server 1030 may be positioned in the same or similar areas or may be positioned in separated areas. For example, the payment service server 1020 may be included in a first server, and the user information analysis server 1030 may be included in a second server. Furthermore, for example, the payment service server 1020 and/or the user information analysis server 1030 may be divided and implemented in one server (e.g., first server or second server).

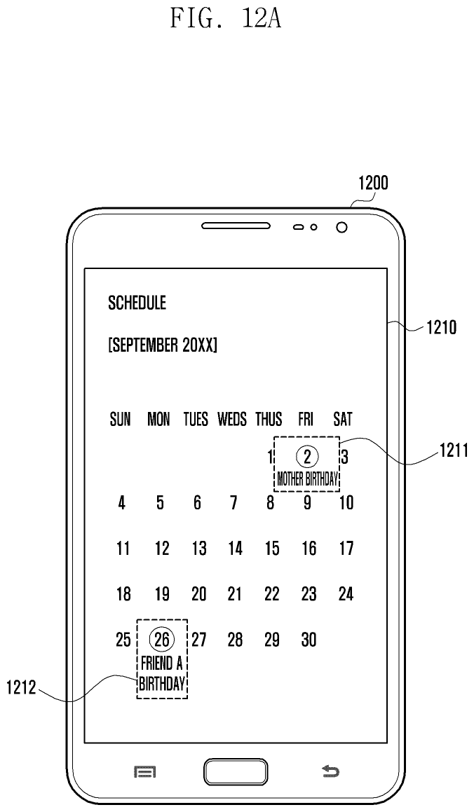

FIG. 11 is a diagram showing a method of providing a user with various pieces of address information related to delivery through an electronic device and user interfaces displaying the method according to various embodiments of the disclosure.

According to various embodiments, an electronic device 1100 (e.g., electronic device 101) may provide a user with a user interface related to product purchase (1110). The electronic device 1100 may display information on a product (e.g., product name, product image, the price of the product), for example. In this case, the user may select the user interface to determine the purchase of the product, for example, and may determine the purchase of the product (1111).

According to various embodiments, for example, when the user determines the purchase of the product, the electronic device 1100 may provide the user with a user interface related to payment (1120). The electronic device 1100 may display information (e.g., Samsung Pay, mobile payment, deposit without a bankbook, real-time account transfer) on various payment means, for example, with respect to the user. In this case, the user may select Samsung Pay, for example, as payment means (1122). Furthermore, for example, when the user selects Samsung Pay as payment means, the electronic device 1100 may execute an application (e.g., payment application 412) capable of performing a payment function.

According to various embodiments, the electronic device 1100 may display information on a card (e.g., card A, card B, card C, card D) used for payment, for example, with respect to the user (1123). In this case, the user may select the card A, for example, as a card used for payment (1124). According to various embodiments, in payment, when a user selects payment means that requires information on a card, the electronic device 1100 may display information on a card used for payment.

According to various embodiments, the electronic device 1100 may display address information (e.g., address 1, address 2, address 3) related to delivery, for example (1130). The electronic device 1100 may display information 1131 on the source of address information related to delivery, for example. For example, when the electronic device 1100 obtains information on the address 1 from a server (e.g., payment service server 420) related to a payment service (e.g., Samsung Pay), the electronic device 1100 may provide the user with the information on the address 1 and a Samsung Pay server, that is, the source of the information on the address 1 (1131). In this case, the user may select the address 1, for example, as the destination of the product (1132).

For example, if information on payment means selected by the user and/or a card used for payment has been previously set, the electronic device 1100 may omit the display of the information 1121 on payment means and/or the information 1123 on a card used for payment.

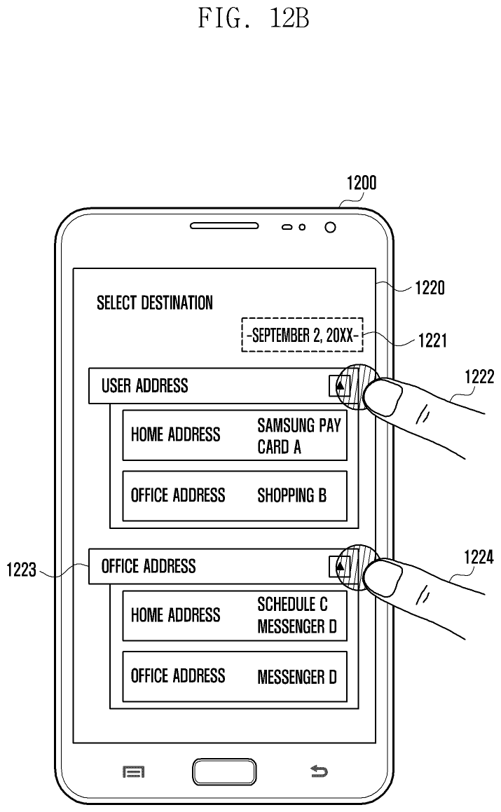

FIG. 12A is a diagram showing an example in which an electronic device displays information on the schedule of a user according to various embodiments of the disclosure. FIG. 12B is a diagram showing a method for an electronic device to provide a user with various pieces of address information related to delivery using information on the schedule of the user and user interfaces displaying the method according to various embodiments of the disclosure.

According to various embodiments, referring to FIG. 12A, an electronic device 1200 (e.g., electronic device 101) may store schedule information of a user, for example, and may display the schedule information of the user (1210). The electronic device 1200 may store and display schedule information including information related to a user or others (e.g., user's mother) related to the user, for example. For example, the electronic device 1200 may store and display information, indicating that the birthday of a user's mother is September 2, 20xx, as schedule information (1211). Alternatively, the electronic device 1200 may store and display information, indicating that the birthday of a user's friend (e.g., friend A) is September 26, 20xx, as schedule information (1212).

According to various embodiments, referring to FIG. 12B, the electronic device 1200 may display address information (e.g., user address, mother address) related to delivery, for example (1220). The electronic device 1200 may display information on the source of address information related to delivery, for example. The electronic device 1200 may display associated address information together from among at least one of address information related to delivery, for example. For example, if the home address of a user and the office address of the user is displayed address information related to delivery, the home address and the office address may be displayed together because they are associated as the address of the user. For example, the electronic device 1200 may provide a user interface related to the display of associated address information. In this case, a user may perform selection so that the home address of a user and the office address of the user indicated as user addresses are not displayed, for example (1222).

The electronic device 1200 may provide a user with various pieces of address information related to delivery, which is related to schedule information of the user, for example. For example, referring to FIG. 12A, the electronic device 1200 may store information, indicating that the birthday of a user's mother is September 2, 20xx, as schedule information. In this case, if the electronic device 1200 provides the user with information on address information related to delivery on September 2, 20xx (1221), it may display the home address and/or office address of the user's mother as the address information related to delivery based on the schedule information. Furthermore, for example, if the home address, office address of the mother is displayed as address information related to delivery, the home address and office address may be displayed together because they are associated as the mother's address. The user may perform selection so that the home address and office address of the mother indicated as the mother addresses are not selected, for example (1224).

When a user purchases a product through an e-commerce method according to the disclosure, the user can select address information provided by an electronic device without directly inputting address information related to delivery. Furthermore, a user can be provided with his or her address information (e.g., user's home address, office address, school address) in various ways. Furthermore, a user can be provided with information on an address (e.g., address related to a family, address related to a friend, a customer address) where a product is to be delivered in various ways.

The embodiments of the disclosure disclosed in the specification and drawings only propose specific examples in order to easily describe the contents according to the embodiments of the disclosure and to help understanding of the embodiments of the disclosure, and are not intended to restrict the scope of the embodiments of the disclosure. Accordingly, in the scope of various embodiments of the disclosure, all changes or modified forms derived based on the technical spirit of various embodiments of the disclosure in addition to the disclosed embodiments should be construed as being included in the scope of various embodiments of the disclosure.

1. An electronic device, comprising:
a display;
a communication circuitry;
a processor electrically connected to the display and the communication circuitry; and
memory electrically connected to the processor,
wherein when the memory is executed, the memory stores instructions enabling the processor to obtain information related to a user, to obtain address information related to delivery from the obtained information related to the user, to display a destination list comprising the obtained address information on the display, and to receive an input to select address information included in the destination list.

2. The electronic device of claim 1, wherein:
the address information related to delivery comprises first address information and second address information,
the first address information comprises address information on the user, and
the second address information comprises address information on others related to the user.

3. The electronic device of claim 1, wherein the instructions enable the processor to transmit the information related to the user to an external electronic device, to request a transmission of a destination list, comprising at least one of address information related to the delivery, from the external electronic device, and to obtain the destination list from the external device.

4. An electronic device providing payment service, comprising:
a communication circuitry;
at least one processor electrically connected to the communication circuitry; and
memory electrically connected to the at least one processor,
wherein the memory stores at least one of address information related to delivery, and
the processor is configured to:
obtain a request for a transmission of a destination list from an external electronic device,
generate a destination list comprising the at least one of address information related to the delivery when the request for the transmission of the destination list is obtained from the external electronic device, and
transmit the generated destination list to the external electronic device.

5. The electronic device of claim 4, wherein the processor is configured to:
request a transmission of the at least one of address information from at least one server, and
obtain the at least one of address information from the at least one server.

6. The electronic device of claim 5, wherein the processor is configured to:
request whether the external electronic device has logged in to the at least one server from at least any one of the external electronic device and the at least one server, and
request whether an account of a user of the external electronic device has been registered with the at least one server from the at least one server based on the external electronic device being not logged in to the at least one server.

7. The electronic device of claim 6, wherein the processor is configured to:
request the transmission of the at least one of address information from the at least one server based on at least any one of the external electronic device being logged in to the at least one server or the account of the user of the external electronic device being registered with the at least one server, and
provide the destination list, comprising at least one of address information stored in the memory, without requesting the transmission of the at least one of address information from the at least one server based on the account of the user of the external electronic device not being registered with the at least one server.

8. The electronic device of claim 5, wherein the processor is configured to:
obtain at least any one of information related to a product or information related to payment means from the external electronic device,
request the transmission of the at least one of address information from the at least one server related to identical information when at least any one of the information related to the product or the information related to the payment means is identical with information on the at least one server stored in the memory, and
provide the destination list, comprising at least one of address information stored in the memory, without requesting the transmission of the at least one of address information from the at least one server when any one of the obtained information related to the product or the information related to the payment means is not identical with the information on the at least one server managed by the electronic device.

9. The electronic device of claim 4, wherein the processor is configured to:
obtain information related to a user from the external electronic device, and
obtain the at least one of address information related to the delivery from the obtained information related to the user.

10. The electronic device of claim 4, wherein the processor is configured to determine order of the at least one of address information included in the destination list based on at least any one of a delivery distance, a time taken for delivery or a delivery history.

11. A method for an electronic device providing payment service to provide delivery information, the method comprising:
obtaining a request for a transmission of a destination list from an external electronic device;
generating the destination list comprising at least one of address information related to delivery based on the request for the transmission of the destination list obtained from the external electronic device; and
transmitting the generated destination list to the external electronic device.

12. The method of claim 11, further comprising:
requesting a transmission of the at least one of address information from at least one serve; and
obtaining the at least one of address information from the at least one server.

13. The method of claim 12, wherein requesting the transmission of the at least one of address information comprises:
requesting at least any one of the external electronic device and the at least one server to identify whether the external electronic device has logged in to the at least one server; and
requesting the at least one server to identify whether an account of a user of the external electronic device has been registered with the at least one server based on the external electronic device not being logged in to the at least one server.

14. The method of claim 13, wherein:
requesting the transmission of the at least one of address information comprises requesting the transmission of the at least one of address information from the at least one server based on at least any one of the external electronic device being logged in to the at least one server or the account of the user of the external electronic device being registered with the at least one server, and
generating the destination list comprises providing the destination list, comprising at least one of address information stored in memory, without requesting the transmission of the at least one of address information from the at least one server based on the account of the user of the external electronic device not being registered with the at least one server.

15. The method of claim 12, further comprising obtaining at least any one of information related to a product or information related to payment means from the external electronic device,
wherein requesting comprises requesting the transmission of the at least one of address information from the at least one server related to identical information when at least any one of the information related to the product or the information related to the payment means is identical with information on the at least one server stored in memory, and
generating the destination list comprises providing the destination list, comprising at least one of address information stored in the memory, without requesting the transmission of the at least one of address information from the at least one server when any one of the obtained information related to the product or the information related to the payment means is not identical with the information on the at least one server managed by the electronic device.
